(19) United States
(12) Patent Application Publication
(10) Pub. No.: US 2004/0162359 A1
(43) Pub. Date: Aug. 19, 2004

(54) Rigid foam from highly functionalized aromatic polyester polyols

(76) Inventors: Thomas Allan Barber, Hendersonville, TN (US); Thomas Roy McClellan, Conroe, TX (US); Melanie McClellan, (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/742,681

(22) Filed: Dec. 19, 2003

Related U.S. Application Data
(60) Provisional application No. 60/436,951, filed on Dec. 30, 2002.

(51) Int. Cl. C08G 18/00

(52) U.S. Cl. 521/159; 521/172; 521/175

(57) ABSTRACT

The present invention provides rigid foams made from aromatic polyester polyols and polyisocyanates. The foams are isocyanate-based foams and are preferably prepared without cell nucleating agents, and are formed from a mixture containing an aromatic polyester polyol, a polyisocyanate, and a blowing agent that includes water. The foams have a high closed cell content with cells having diameters of about 160 microns or less, high thermal resistance, and flame retardancy.

### PRIORITY

This application claims priority from provisional patent application serial No. 60/436,951, filed Dec. 30, 2002, the disclosures of which are hereby incorporated herein by reference in their entirety.

### FIELD OF THE INVENTION

This invention relates to rigid foams, and in particular to foams made from aromatic polyester polyols and polyisocyanates.

### BACKGROUND OF THE INVENTION

The term “rigid foams” is commonly used to refer to plastics with a cell structure produced by an expansion process, known as “foaming”, and also having a comparatively low weight per unit volume and with low thermal conductivity. Optionally, the foaming process can be carried out substantially simultaneously with the production of the plastic. Such rigid foams are often used as insulators for noise abatement and/or as heat insulators in construction, in cooling and heating technology such as for household appliances, for producing composite materials, such as sandwich elements for roofing and siding, and for wood simulation material, model-making material, and packaging.

Rigid foams based on polyurethane and polyisocyanurate are known and are produced, for example, by an exothermic reaction of a polyol with an isocyanate. Foams made using a stoichiometrically balanced mixture of polyol and isocyanate are known as polyurethane foams. If a sufficient excess of isocyanate is used, isocyanurates are formed by trimerization of isocyanate, leading to increased crosslinking and increased thermal and flame resistance and low smoke generation during burning; however, such materials have inferior mechanical properties. Encyclopedia of Polymer Science and Engineering, 2^{nd} ed., J. Kroschwitz, Exec. Ed. (John Wiley & Sons, NY (1988), vol. 3, p. 27.

The speed of reaction in forming a foam can be adjusted by the use of a suitable activator. In order to provide foaming, use is made of an inflating agent having a suitable boiling point, typically soluble in the polyol, that becomes a gas upon reaching its boiling point and thereby produces pores, referred to as “cells”. To improve flowability of the reactants during manufacture of foams for use in molding or panel manufacturing, water is generally added to the polyol and reacts with the isocyanate, forming carbon dioxide, which acts as an additional inflating agent.

Surfactants can be added to the isocyanate/polyol reaction mixture to assist in cell formation, and nucleation or charging of the foaming mixture with a gas is often used to enhance cell structure. It is desirable, in the formation of rigid foams, to obtain as many small, closed cells as possible.

Concerns about the deleterious environmental effects of chlorofluorocarbons and hydro chlorofluorocarbons have resulted in a need for effective, environmentally benign replacements. Carbon dioxide produced when water is added to the isocyanate/polyol mixture can be used as an inflating agent, but its thermal conductivity is higher than the thermal conductivity of the fluorocarbons, which adversely affects the insulating capability of a foam made using carbon dioxide.

U.S. Pat. No. 5,034,424 to Wenning et al. discloses rigid foams, including a closed-cell polyurethane or polyisocyanurate rigid foam, that includes a cell structure formed by the expansion of rigid foam raw materials with carbon dioxide as an inflating agent, and one other inflating agent that is substantially insoluble in at least one of the raw materials, i.e., polyols and isocyanates, used to make the foam. The insoluble inflating agent is homogeneously emulsified in at least one of the rigid foam raw materials prior to the reaction between the polyol and isocyanate, and is provided in the disperse phase of an emulsion having a liquid droplet size of 10 μm or less in diameter. The amount of inflating agent is less than 3.5 weight percent % of the mixture. Activators and/or stabilizers are optionally additionally used to form the cell structure. Wenning also discloses the use of particulate nucleating agents, i.e., silica gel and starch.

There remains a need for very fine closed-cell rigid foams with high insulation value, high compressive strength, and low flame spread.

### SUMMARY OF THE INVENTION

According to one aspect, the present invention provides a closed cell, isocyanate-based, rigid foam, having an insulation value of at least 4.5 R/in, formed from a mixture containing an aromatic polyester polyol; a polyisocyanate, in such quantity that the isocyanate index in the mixture is less than 3.5; and a blowing agent. The blowing agent comprises water. In some embodiments, the blowing agent consists essentially of water. In some embodiments, water is the only blowing agent used. In other embodiments, the mixture also contains a co-blowing agent comprising at least one compound whose boiling point is lower than 60° C.

The aromatic polyester polyol has an average hydroxyl functionality greater than 2. Preferably, the average hydroxyl functionality of the aromatic polyester polyol is about 2.3 or greater, more preferably about 2.5 or greater. Most preferably, the hydroxyl functionality of the aromatic polyester polyol is from about 2.7 to about 3.0. Also preferably, the foam is prepared without the use of nucleating agents other than surfactants. The mixture preferably contains no alkoxylated polyols and no partially alkoxylated polyols. As used herein, a partially alkoxylated polyol is a polyol in which at least one hydroxyl group has not reacted with an alkoxylating agent. A fully alkoxylated polyol, also referred to herein as simply an “alkoxylated polyol”, is a polyol in which all hydroxyl groups have reacted with an alkoxylating agent. A fully akoxylated polyol is also known to those skilled in the art as a polyether polyol.

In some embodiments, the mixture also contains from about 0.05 to about 1.5 wt %, preferably from about 0.8 to about 1.35 wt. %, more preferably from about 0.9 to about 1.25 wt. %, based on the total weight of the reaction mixture, of at least one surfactant. Large quantities of surfactant are not needed to produce the foam structure according to the methods described herein.

In some embodiments, the mixture contains one or more additives selected from catalysts, flame retardants and saccharides.

Another aspect of the invention is a process for making a foam, comprising providing an aromatic polyester polyol, providing a polyisocyanate, providing a blowing agent comprising water, mixing the aromatic polyester polyol, the polyisocyanate and the blowing agent at a temperature from about 0° C. to about 150° C. in the presence of a catalyst, and allowing the aromatic polyester and the polyisocyanate to react to form the foam. The polyisocyanate is provided in such quantity that the isocyanate index in the foam is less than 3.5. The polyol, blowing agent, catalyst, and any optional additives can be combined sequentially in any order, or simultaneously. However, it is highly preferred that all other components are combined prior to adding the polyisocyanate. Thus, the term “reaction mixture”, as used herein, may be used when two or more components of the mixture have been combined, or to refer to all components of the mixture prior to their having been combined, and does not necessarily require that all components are present at all times simultaneously.

Cells in the foams made according to the processes disclosed herein preferably have average equivalent diameters of 160 microns or less. In some embodiments, the foams have a mean cell diameter of about 140 microns or less. In some preferred embodiments, the foams have a mean cell diameter of about 110 microns or less.

In preferred embodiments, the foams have an average core density of 1.4 to 2.5 pounds per cubic foot (pcf). Also in preferred embodiments, the foams have a closed cell content greater than 50%. More preferably, the closed cell content of the foams is 60% or more, even more preferably 70% or more, still more preferably 80% or more, and most preferably 85% or more. In some embodiments, the foams can have a closed cell content of about 90% or more.

In preferred embodiments, the foams have a compressive strength greater than 15 psi. More preferably, the compressive strength is 20 psi or greater, even more preferably 25 psi or greater, still more preferably 30 psi or greater, still even more preferably 35 psi or greater, and yet even more preferably 40 psi or greater.

### BRIEF DESCRIPTION OF THE DRAWINGS

FIG. 1 is a drawing depicting an apparatus useful for forming a rigid foam according to the processes of the present invention.

FIG. 2 is an example of an optical confocal micrograph image of a foam produced according to Example 3.

FIG. 3 is a scanning electron micrograph of a foam produced according to Example 3.

### DETAILED DESCRIPTION

The present invention provides rigid foams having a high closed cell content and cells having diameters of about 160 microns or less, desirably about 150 microns or less, preferably about 140 microns or less, more preferably about 135 microns or less, even more preferably about 130 microns or less, more preferably about 125 microns or less, even more preferably about 115 microns or less, still more preferably about 110 microns or less, and still even more preferably about 105 microns or less, as measured by SEM (scanning electron microscopy). In some highly preferred embodiments, the foams have cell sizes of about 100 microns or less.

In forming the foams, particulate cell nucleating agents (e.g., graphite, starch, silica) are not necessary. In some embodiments, one or more frothing agents are used. Frothing agents can function, in part, as cell nucleating agents.

The foams combine the desirable flammability characteristics of a polyisocyanurate rigid foam with the compressive strength of a polyurethane rigid foam. The Isocyanate index used in making the foams is economically advantageous, since polyisocyanates are generally more expensive than aromatic polyester polyols.

The cell diameters recited herein are based on measurements made using scanning electron microscopy (SEM). As will be recognized by one skilled in the art, the cell size measured can be affected by the measurement technique used. For example, optical measurements are generally not preferred for use in measuring cell sizes less than 200 microns. Also, optical measurement techniques can yield smaller diameters for the same cells than when the cells are measured using microscopic techniques. SEM is preferred for measuring cell diameters of rigid foams made according to the processes described herein.

It has been surprisingly found that rigid foams having desirably high insulation properties can be obtained using water as a blowing agent, even as the principal or only blowing agent. The rigid foams are made from an aromatic polyester polyol. In particular, the foams are made from a mixture that contains an aromatic polyester polyol, a polyisocyanate, and a blowing agent containing water. The amount of polyisocyanate is such that the mixture has an isocyanate index less than 3.5, preferably about 3.0 or less, more preferably about 2.5 or less, even more preferably about 1.7 or less. It has also been surprisingly found that foams having isocyanate indices within the range of 0.85 to 2.5 having cell sizes less than about 160 microns, and even as small as 110 microns or less, can be formed from aromatic polyester polyols. More preferably, for desirable strength in rigid foams, the foams have isocyanate indices of at least about 1.0.

Unless otherwise stated, the following terms as used herein have the following definitions.

A “rigid” foam is a foam that ruptures when a 20×2.5×2.5 cm piece of the foam is wrapped around a 2.5 cm mandrel rotating at a uniform rate of 1 lap per second at 15-25° C.

“Hydroxyl number” refers to the concentration of hydroxyl groups, per unit weight of the polyol, that are able to react with the isocyanate groups. Hydroxyl number is reported as mg KOH/g, and is measured according to the standard ASTM D 1638.

“Acid number” correspondingly indicates the concentration of carboxylic acid groups present in the polyol, and is reported in terms of mg KOH/g and measured according to standard ASTM 4662-98.

The “average functionality”, or “average hydroxyl functionality” of a polyol indicates the number of OH groups per molecule, on average. The average functionality of an isocyanate refers to the number of —NCO groups per molecule, on average.

“Glycols”, also referred to as “dihydric alcohols”, are low molecular weight hydroxy compounds containing 2 hydroxyl groups, preferably having an average molecular weight of about 62 to 260.

“Polyhydroxyl polyol” or “polyhydric alcohols” are low molecular weight hydroxy compounds containing 3 to 8 hydroxyl groups, preferably having an average molecular weight of about 90 to about 350.

“Polyisocyanate” indicates an organic isocyanate component that has two or more isocyanate functionalities.

“Isocyanate index” indicates the ratio of isocyanate equivalents present in the mixture to the stoichiometrically calculated amount based on hydroxyl groups. Other terms used in the art for “isocyanate index” are “NCO:OH ratio” and “NCO:OH equivalent ratio.” Typically, the use of an aromatic polyester polyol provides an isocyanate index of about 2.5 or greater. While an isocyanate index of about 2.5 or less can be obtained by using a highly functionalized polyether polyol, the use of a highly functionalized aromatic polyester polyol eliminates the need for such highly functionalized polyether polyols.

Foams, such as those described herein, having a “high closed cell content” have a relatively large fraction of noninterconnecting cells, in contrast to cells having a large fraction of interconnected cells, which are commonly known as “open-celled foams”. A foam having a high closed cell content can nonetheless have some interconnected cells. Preferably, the foam has 50% or more, more preferably at least about 60%, even more preferably at least about 70% and still more preferably at least about 80% closed cells.

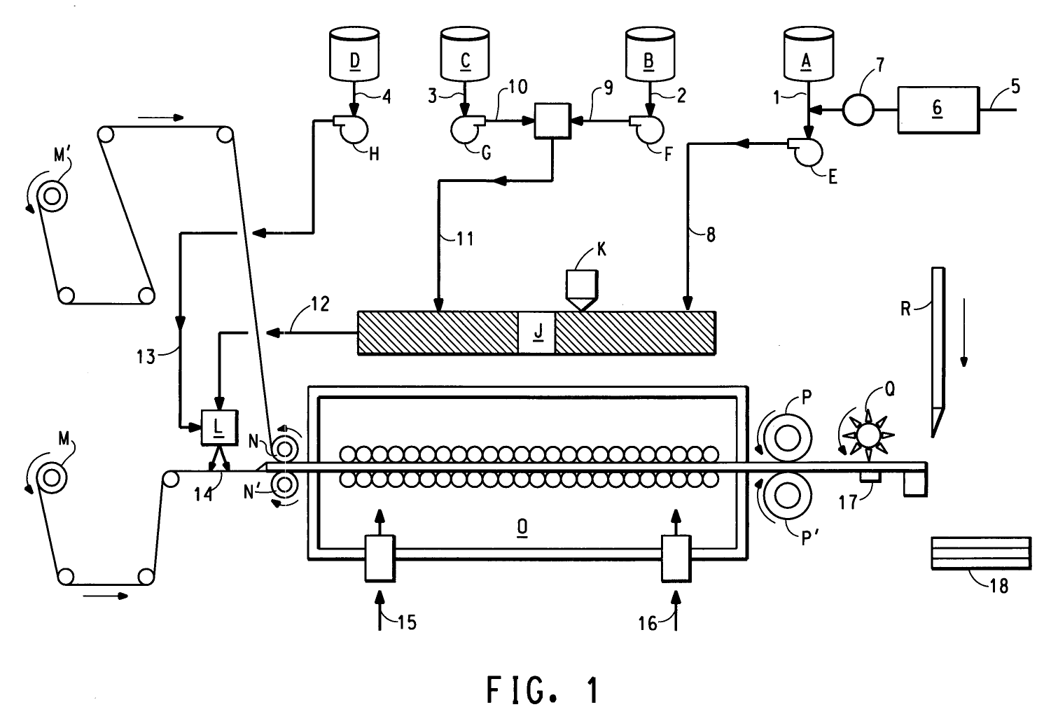

In polyisocyanate-based foam production, where ingredients are mixed together from different tanks (see, e.g., FIG. 1) conventional terminology is used herein to designate the components mixed together to make a foam. Such conventional terminology is used herein. In particular:

“A-side” refers to the liquid component containing the polyisocyanate.

“B-side” refers to the liquid component containing the polyol, surfactant, and blowing agent.

“C-side” refers to the component containing alternative blowing agent.

“D-side” refers to the component containing a catalytic agent.

Unless otherwise specified, weight percentages recited herein for components of a foam or a mixture used to make a foam are by weight, based on the total weight of the foam or mixture.

The foams are formed from a mixture comprising a polyol component comprising an aromatic polyester polyol and a polyisocyanate, and the aromatic polyester polyol optionally comprising a functionality-enhancing polyhydroxyl polyol component. Exemplary functionality-enhancing polyhydroxyl polyol components of the aromatic polyester polyol are saccharides, such as sorbitol. According to the processes herein, it is preferred that the functionality-enhancing polyhydroxy polyol component is reacated into the aromatic polyester polyol, i.e., is included within the components used to make the aromatic polyester polyol. Methods useful in making polyester polyols having such functionality-enhancing polyhydroxy polyols therein are disclosed in co-pending U.S. patent application Ser. No. 10/619,722, filed Jul. 15, 2003, the disclosures of which are incorporated herein by reference in their entirety. The aromatic polyester polyol preferably has a hydroxyl functionality of 2 or greater. Preferably, the hydroyxyl functionality is 2.5 or greater, more preferably 2.7 or greater. Most preferably, the hydroxyl functionality is from about 2.7 to about 3.0.

In addition to the above-described aromatic polyester polyol, the polyol component can also contain one or more other polyols. The other polyols can be polyester polyols, or can be other types of polyols such as polyether polyols. For example, a blend of two or more polyols may be used. When the polyol component contains other polyols, polyester polyols are preferred as the other polyols. When one or more other polyols that are not polyester polyols are present in the polyol component, preferably at least about 50% by weight of the total polyol component in the mixture used to make a foam is an aromatic polyester polyol. More preferably, at least about 75% by weight of the polyol component is an aromatic polyester polyol. Even more preferably, at least 85% by weight of the polyol component is an aromatic polyester polyol. In certain highly preferred embodiments, substantially all, e.g., at least about 98% by weight, 99% by weight or even about 100% by weight of the polyol component is an aromatic polyester polyol. However, the term “substantially all” aromatic polyester polyol is intended to include two or more aromatic polyester polyols and is used only to exclude other polyols that are not aromatic polyester polyols. When substantially all of the polyol is an aromatic polyester polyol, the polyol may be referred to as “consisting essentially of” an aromatic polyester polyol.

For example, polyoxyalkylene polyether polyols, which can be obtained by known methods, can be mixed with the aromatic polyester polyols. Polyether polyols can be produced by anionic polymerization with alkali hydroxides such as sodium hydroxide or potassium hydroxide or alkali alcoholates, such as sodium methylate, sodium ethylate, potassium ethylate or potassium isopropylate as catalysts and with the addition of at least one initiator molecule containing about 2 to 8, more preferably 3 to 8, reactive hydroxyl groups. For example, the initiator can contain 2, 3, 4, 5, 6, 7, or 8 reactive hydroxyl groups. Polyether polyols can also be produced by cationic polymerization, with Lewis acids such as antimony pentachloride, boron trifluoride etherate as catalysts, from one or more alkylene oxides with 2, 3 or 4 carbons in the alkylene radical. Any suitable alkylene oxide can be used such as 1,3-propylene oxide, 1,2-butylenes oxide, 2,3-butylene oxide, amylene oxides, styrene oxide, ethylene oxide, 1,2-propylene oxide or mixtures of such oxides. Polyalkylene polyether polyols can also be prepared from other starting materials such as tetrahydrofuran and alkylene oxide-tetrahydrofuran mixtures; epihalohydrins such as epichlorohydrin; and aralkylene oxides such as styrene oxide. The polyalkylene polyether polyols may have either primary or secondary hydroxyl groups. Exemplary polyether polyols are polyoxyethylene glycol, polyoxypropylene glycol, polyoxybutylene glycol, and polytetramethylene glycol.

Preferred polyether polyols include the alkylene oxide addition products of polyhydric alcohols such as ethylene glycol, propylene glycol, dipropylene glycol, trimethylene glycol, 1,2-butanediol, 1,5-pentanediol, 1,6-hexanediol, 1,7-heptanediol, hydroquinone, resorcinol glycerol, glycerine, 1,1,1-trimethylol-propane, 1,1,1-trimethylolethane, pentaerythritol, 1,2,6-hexanetriol, alpha.-methyl glucoside, sucrose, and sorbitol. Also included within the term “polyhydric alcohol” are compounds derived from phenol, such as 2,2-bis(4-hydroxyphenyl)-propane, commonly known as Bisphenol A.

In some embodiments, the highly functionalized aromatic polyester polyol can be used in combination with a less functionalized aliphatic or aromatic polyester polyol. For example, an aromatic polyester polyol such as Kosa Terate®3522 or Stepanol®2412 can be blended with the highly functionalized aromatic polyester polyol to make the polyol component. An aliphatic polyester polyol such as adipate polyol can also be blended with the highly functionalized aromatic polyester polyol. Preferably, a polyol component made from such a blend contains at least about 5%, more preferably at least about 10%, even more preferably at least about 20 weight %, still more preferably at least about 25 weight %, still even more preferably at least about 30 weight %, more preferably at least about 35 weight %, even more preferably at least about 50 weight %, still even more preferably at least about 75 weight %, more preferably at least about 80%, even more preferably at least about 85 weight %, still more preferably at least about 90 weight %, and still even more preferably at least about 95 weight % highly functionalized aromatic polyester polyol, based on the total polyester polyol content in the reaction mixture. Aliphatic polyester polyols can be blended with the highly functionalized aromatic polyester polyol.

Suitable aromatic polyester polyols are reaction products of a reaction mixture comprising an acid component, a glycol component, and optionally a polyhydric polyol. Preferably a urethane catalytic activity agent is also included. Preferred aromatic polyester polyols are described in co-pending U.S. patent application Ser. No. 10/619,722, filed Jul. 15, 2003, already incorporated by reference herein in its entirety.

Preferred aromatic polyester polyols used in the processes disclosed herein have, as a molar percentage of the total acid groups used to make a particular polyol, a molar aromatic content of at least about 10%, i.e., a molar aliphatic acid content of about 90% or less. Preferably, the aromatic acid portion of the total acid is at least about 20 mol %, more preferably at least about 30 mol %, even more preferably at least about 40 mol %, still more preferably at least about 50 mol %, still even more preferably at least about 60 mol %, even more preferably at least about 70 mol %, still even more preferably at least about 80 mol %, yet even more preferably at least about 90 mol %, and most preferably, about 100 mol %.

The aromatic polyester polyols used in making the foams have an average hydroxyl functionality greater than 2. Preferably, the hydroxyl functionality is 2.5 or greater, more preferably 2.7 or greater. Most preferably, the hydroxyl functionality is from about 2.7 to about 3.0. However, while 3.0 is the practical upper limit of hydroxyl functionality for some compositions and conditions, the use of polyester polyols having hydroxyl functionalities greater than 3.0 is within the scope of the present invention. In addition, the aromatic polyester polyols suitable for use in the present invention preferably have an acid number below 3.0 mg KOH/g, as measured according to ASTM D4662-98, more preferably from about 0.1 to about 2.98 mg KOH/g. Furthermore, the aromatic polyester polyols preferably have a hydroxyl value of 250-600 mg KOH/g, more preferably 300-450 mg KOH/g, and even more preferably 330-400 mg KOH/g. The aromatic polyester polyols also preferably have a kinematic viscosity at 25° C. of 2,500-100,000 centiStokes (cSt), more preferably 3500-10,000 cSt, even more preferably 4000-6000 cSt. For some applications, viscosities at the lower end of the recited ranges are preferred, although in order to obtain very low viscosities, functionality may be significantly reduced.

The acid component used in making the aromatic polyester polyol can include a carboxylic acid or acid derivative, such as an anhydride or ester of the carboxylic acid. Examples of suitable carboxylic acids and derivatives thereof useful as the acid component for the preparation of the aromatic polyester polyol include: oxalic acid; malonic acid; succinic acid; glutaric acid; adipic acid; pimelic acid; suberic acid; azelaic acid; sebacic acid; phthalic acid; isophthalic acid; trimellitic acid; terephthalic acid; phthalic acid anhydride; tetrahydrophthalic acid anhydride; pyromellitic dianhydride; hexahydrophthalic acid anhydride; tetrachlorophthalic acid anhydride; endomethylene tetrahydrophthalic acid anhydride; glutaric acid anhydride; maleic acid; maleic acid anhydride; fumaric acid; dibasic and tribasic unsaturated fatty acids optionally mixed with monobasic unsaturated fatty acids, such as oleic acid; terephthalic acid dimethyl ester and terephthalic acid-bis-glycol ester. While the acid component can be a substantially pure reactant material, the acid component is preferably a side-stream, waste, or scrap residue from the manufacture of compounds such as, for example, phthalic acid, terephthalic acid, dimethyl terephthalate, polyethylene terephthalate, polybutylene terephthalate, polytrimethylene terephthalate, or adipic acid. Preferred aromatic carboxylic acid components include ester-containing by-products from the manufacture of dimethyl terephthalate, scrap polyalkylene terephthalates, phthalic anhydride, residues from the manufacture of phthalic anhydride, terephthalic acid, residues from the manufacture of terephthalic acid, isophthalic acid, trimellitic anhydride, residue from the manufacture of trimellitic anhydride, aliphatic polybasic acids or esters derived therefrom, scrap resin from the manufacture of biodegradable polymers such as Biomax® polymers (E. I. du Pont de Nemours and Company, Wilmington, Del.), and by-products from the manufacture of polyalkylene terephthalate.

The glycol component used in making the aromatic polyester polyol can be aliphatic, cycloaliphatic, aromatic and/or heterocyclic. Preferably, the glycol component is an aliphatic dihydric alcohol having no more than about 20 carbon atoms. In one embodiment, the glycol comprises ethylene glycol, propylene glycol, diethylene glycol, triethylene glycol, polyethylene glycol, dipropylene glycolbutylene glycol-(1,4) and -(2,3); hexanediol-(1,6); octane diol-(1,8); neopentyl glycol; 1,4-bishydroxymethyl cyclohexane; 2-methyl-1,3-propane diol, or a mixture thereof. Suitable glycol component side-stream sources include ethylene glycol, diethylene glycol, triethylene glycol, and higher homologs or mixtures thereof. The similar homologous series of propylene glycols can also be used. Glycols can also be generated in situ during preparation of the aromatic polyester polyols of the invention by depolymerization of polyalkylene terephthalates. For example, depolymerization of polyethylene terephthalate yields ethylene glycol. The glycol component optionally can include substituents that are inert in the reaction forming the polyol, such as chlorine and bromine substituents, and/or can be unsaturated. The most preferred glycol components are diethylene glycol and ethylene glycol generated in situ.

In addition to or as an alternative to the glycols, a polyhydric alcohol can be used in preparing the polyester polyols. Useful polyhydric alcohols can be aliphatic, cycloaliphatic, aromatic and/or heterocyclic. Exemplary functionality-enhancing polyhydroxyl polyol components include non-alkoxylated glycerol, non-alkoxylated pentaerythritol, non-alkoxylated α-methylglucoside, non-alkoxylated sucrose, non-alkoxylated sorbitol, non-alkoxylated tri-methylolpropane, non-alkoxylated,trimethylolethane, tertiary alkynol amines, and non-alkoxylated mono-di, tri, and poly saccharides. Mixtures of two or more of such functionality-enhancing polyol components can be used. Of the saccharides, sugars that contain no aldehyde functionality, such as xylose, mannitol, and sorbitol are preferred. Sorbitol is most preferred.

The polyester polyols optionally can include substituents that are inert in the reaction between the polyester polyol and the isocyanate, such as, for example, chlorine and bromine substituents, and/or can be unsaturated. Amino alcohols, such as, for example, monoethanolamine, diethanolamine, triethanolamine, or the like, can also be used. Triethanolamine or a side stream source such as the bottoms from triethanol amine refining is preferred.

The aromatic polyester polyol can optionally include unreacted glycols or polyhydroxyl polyol compounds remaining after the preparation of the aromatic polyester polyol in relatively minor amounts, e.g., about 25% or less by weight, based on the weight of the aromatic polyester polyol. In a preferred embodiment of the invention, residue metal esterification catalyst and glycolates, carboxylates, and other coordination compounds of the metal resulting from formation of the aromatic polyester polyol are not substantially removed prior to reacting the aromatic polyester polyol with the other components used in making the foam. The term “not substantially removed” is intended to mean that the residue metal esterification catalyst and glycolates, carboxylates, and other metal compounds thereof are not intentionally removed from the aromatic polyester polyol. Thus, in some preferred embodiments, at least 10%, preferably at least 20%, more preferably at least 30%, even more preferably at least 40%, still more preferably at least 50%, even more preferably at least 60%, yet even more preferably at least 70%, still even more preferably at least 80%, and still yet even more preferably at least 90% of the residue metal esterification catalyst and glycolates, carboxylates, and other coordination compounds of the metal resulting from formation of the aromatic polyester polyol are not removed prior to reacting the aromatic polyester polyol with the other components used in making the foam.

Activators or catalysts can be used to enhance the speed of the foam-making reaction. Suitable catalysts are compounds that accelerate the reaction of the polyols with the polyisocyanates. Useful organic and inorganic salts, coordination complexes, and organometallic derivatives include those of bismuth, lead, tin, titanium, iron, antimony, uranium, cadmium, cobalt, thorium, aluminum, mercury, zinc, nickel, cerium, molybdenum, vanadium, copper, manganese, titanium, and zirconium. Preferred are organic tin compounds such as tin (II) salts of organic carboxylic acids, e.g., tin (II) acetate, tin (II) octanoate, tin (II) ethylhexanoate and tin (II) laurate, and dialkyltin (IV) salts of organic carboxylic acids, e.g., dibutyltin diacetate, dibutyltin diacetate, dibutyltin dilaurate, dibutyltin maleate, and dioctyltin diacetate are suitable. Further examples of suitable metal catalysts include bismuth nitrate, lead 2-ethylhexoate, lead benzoate, lead oleate, dibutyltin dilaurate, tributyltin, butyltin trichloride, stannic chloride, stannous octoate, stannous oleate, dibutyltin di (2-ethylhexoate), ferric chloride, antimony oxide, antimony trichloride, antimony glycolate, manganese acetate, manganese glycolate, and tin glycolate. The organic metal compounds can be used alone but are preferably used in combination with strong basic amines. Examples of such amines include 2,3-dimethyl-3,4,5,6-tetrahydropyrimidine, tertiary amines such as triethylamine, tributylamine, dimethylbenzylamine, N-methylmorpholine, N-ethylmorpholine, N-cyclohexylmorpholine, N,N,N′N,′-tetramethylethylenediamine, N,N, N′,N′-tetraymethylbutanediamine, or -hexanediamine, pentamethyldiethylenetriamine, tetramethyldiaminoethyl ether, bis(dimethylaminopropyl)urea, dimethylpiperazine, 1,2-dimethylimidazole, 1-azabicyclo[3.3.0]octane and preferably 1,4-diaza-bicyclo[2.2.-2]octane and alkanolamine compounds such as triethanolamine, triisopropanolamine, N-methyl- and N-ethyldiethanolamine and dimethylethanolamine. Other suitable catalysts include tris-(dialkylamino-s-hexahydrotriazines, especially tris(N,N-dimethylaminopropyl)-s-hexahydrotriazine, tetralkylammonium hydroxides such as tetramethylammonium hydroxide, alkali hydroxides such as sodium hydroxide and alkali alcoholates such as sodium methylate and potassium isopropylate as well as alkali salts of long chain fatty acids with 10 to 20 carbons and optionally OH dependent groups. Preferred catalysts are urethane catalytic activity agents, as disclosed in U.S. patent application Ser. No. 10/619,722, already incorporated herein by reference.

Polyisocyanates for use in making the foams can be selected from any organic polyisocyanates known to those skilled in the art. The term “polyisocyanate” is intended to include di-isocyanates and isocyanates with more than two isocyanate functionalities. Examples of suitable organic polyisocyanates include aliphatic, cycloaliphatic, arylaliphatic, aromatic and heterocyclic polyisocyanates and combinations thereof that have two or more isocyanate (NCO) groups per molecule. The polyisocyanate is used in such quantity that the Isocyanate index in the mixture is less than 3.5, preferably less than 2.5, and more preferably less than 1.7. It is highly preferred that the isocyanate index be about 1.3 or less. It is also preferred that the isocyanate index be at least about 1.0.

Among the many polyisocyanates suitable for use in the processes disclosed herein are, for example, tetramethylene, hexamethylene, octamethylene and decamethylene diisocyanates, and their alkyl substituted homologs, 1,2-, 1,3- and 1,4-cyclohexane diisocyanates, 2,4- and 2,6-methyl-cyclohexane diisocyanates, 4,4′- and 2,4′-dicyclohexyl-diisocyanates, 4,4′- and 2,4′-dicyclohexylmethane diisocyanates, 1,3,5-cyclohexane triisocyanates, saturated (hydrogenated) polymethylenepolyphenylenepolyisocyanates, isocyanatomethylcyclohexaneisocyanates, isocyanatoethyl-cyclohexane isocyanates, bis(isocyanatomethyl)-cyclohexane diisocyanates, 4,4′- and 2,4′-bis(isocyanatomethyl) dicyclohexane, isophorone diisocyanate, 1,2-, 1,3-, and 1,4-phenylene diisocyanates, 2,4- and 2,6-toluene diisocyanate, 2,4′-, 4,4′- and 2,2-biphenyl diisocyanates, 2,2′-, 2,4′- and 4,4′-diphenylmethane diisocyanates, polymethylenepolyphenylene-polyisocyanates (polymeric MDI), and aromatic aliphatic isocyanates such as 1,2-, 1,3-, and 1,4-xylylene diisocyanates.

Organic polyisocyanates containing heteroatoms such as, for example, those derived from melamine, can also be used. Polyisocyanates modified by carbodiimide or isocyanurate groups can also be employed. Liquid carbodiimide group- and/or isocyanurate ring-containing polyisocyanates having an isocyanate content of 15 wt % to 33.6 wt %, preferably 21 wt % to 31 wt %, are also useful, such as those based on 4,4′-, 2,4′-, and/or 2,2′-diphenylmethane diisocyanate and/or 2,4-and/or 2,6-toluene diisocyanate. Preferred are 2,4- and 2,6-toluene diisocyanate and the corresponding isomer mixtures, 4,4′-, 2,4′, and 2,2′-diphenylmethane diisocyanates as well as the corresponding isomer mixtures, for example, mixtures of 4,4′- and 2,4′-diphenylmethane diisocyanates, mixtures of diphenylmethane diisocyanates (MDI) and polyphenyl polymethylene polyisocyanates (polymeric MDI), and mixtures of toluene diisocyanates and polymeric MDI.

Still other useful organic polyisocyanates are isocyanate terminated prepolymers. Isocyanate terminated prepolymers are prepared by reacting an excess of one or more organic polyisocyanates with a minor amount, e.g., about 10 weight percent or less, based on the weight of the polyisocyanate, of one or more active hydrogen-containing compounds. A large molar excess of isocyanate is desired, e.g, a molar excess of about 600% or greater, preferably up to about 900%. Suitable active hydrogen containing compounds for preparing the prepolymers are those containing at least two active hydrogen-containing groups that are isocyanate reactive. Typifying such compounds are hydroxyl-containing polyesters, polyalkylene ether polyols, hydroxyl-terminated polyurethane oligomers, polyhydric polythioethers, ethylene oxide adducts of phosphorous-containing acids, polyacetals, aliphatic polyols, aliphatic thiols including alkane, alkene, and alkyne thiols having two or more SH groups, as well as mixtures thereof. Compounds that contain two or more different groups within the above-defined classes can also be used such as, for example, compounds that contain both an SH group and an OH group. Highly useful prepolymers are disclosed in U.S. Pat. No. 4,791,148 to Riley et al., the disclosures of which are hereby incorporated by reference.

Preferred polyisocyanates are aromatic diisocyanates and aromatic polyisocyanates. Particularly preferred are 2,4′-, 2,2′- and 4,4′-diphenylmethane diisocyanate (MDI), polymethylene polyphenylene polyisocyanates (polymeric MDI), and mixtures of the above preferred polyisocyanates. Most preferred are the polymeric MDIs. A preferred polymeric MDI is a polymeric diphenylmethane 4,4′-diisocyanate with a dynamic viscosity of 60 to 3000 cPs at room temperature, more preferably 200 to 2000 cPS, and most preferably 400 to 800 cPs.

Water is a preferred blowing agent for forming the rigid foams. Generally, when water is used as a blowing agent, at least about 0.1 weight percent based on the total weight of the polymerized reaction mixture is used. Although as little as 0.1 or 0.15 weight percent of water can be used as a blowing agent for making foams according to the processes disclosed herein, a preferred amount of water for use as a blowing agent in making the foams is from about 0.25 weight % to about 1.0 weight %, more preferably from about 0.38 to about 0.65 weight %. Most preferably, at least about 0.4 weight percent of water is used. Preferably, water is the sole blowing agent. In a preferred embodiment, when water is the sole blowing agent, the amount of water is from about 1.5 weight % to about 2.0 weight %, based on the total weight of the polymerized reaction mixture. An advantage of the foams made according to the processes disclosed herein is that foams made with relatively high contents of water as one or the sole blowing agent provide unexpectedly good insulation.

Optionally, one or more other blowing agents may be used. Such additional blowing agents are referred to herein as “co-blowing agents”. Co-blowing agents suitable for use in making the rigid foams include conventional blowing agents such as hydrocarbons and hydrofluorocarbons. Exemplary co-blowing agents are C₂-C₆ hydrocarbons and hydrofluorocarbons. Preferred co-blowing agents are isopentane, n-pentane, cyclopentane and 1,1,1,2-tetrafluoroethane. Mixtures of two or more co-blowing agents can be used. A mixture of isopentane, n-pentane and/or cyclopentane can be referred to as “pentane”. For example, pentane can be used, as a co-blowing agent with water, in an amount of about 7.5 weight % to 3.5 weight %, preferably about 7.0 weight percent to about 5.0 weight percent, more preferably about 5.3 weight percent to about 4.0 weight percent, and still more preferably about 4.6 weight %, based on the total weight of the polymerized reaction mixture. A higher amount of pentane generally results in the foam having a lower density. Co-blowing agents are advantageously employed in a total amount sufficient to give the resultant rigid foam the desired bulk density, generally between 0.5 and 10 pounds per cubic foot, preferably between 1 and 5 pounds per cubic foot, and more preferably between 1.5 and 2.5 pounds per cubic foot. The blowing agents are preferably present in the mixture used to make the foam in an amount from about 0.5 to about 20 wt %, more preferably from about 1 to about 15 wt %, based on the total weight of the mixture. When a blowing agent has a boiling point at or below ambient temperature, the blowing agent can be maintained under pressure until the blowing agent is mixed with the other components.

It is preferred that co-blowing agents for use in the foams have boiling points less than about 60° C., more preferably less than about 50° C. When a blowing agent has a boiling point at or below ambient temperature, the blowing agent can be maintained under pressure until the blowing agent is mixed with the other components. However, if a blowing agent having too high a boiling point is used, the blowing agent can act as a solvent.

In some embodiments, a frothing agent can be used. A frothing agent, if used, introduces a gas into the polyol. Exemplary frothing agents are carbon dioxide, air, and nitrogen. Carbon dioxide is a preferred frothing agent, and is preferably introduced into the polyol in liquid form. Liquid carbon dioxide is introduced at a temperature below the gas transition temperature, then allowed to convert to carbon dioxide gas as the temperature is allowed to rise. The frothing agent is typically added at the B side, as shown in FIG. 1.

Any suitable surfactant can be employed in making the foams. Examples of suitable surfactants are compounds that serve to regulate the cell structure of the plastics by helping to control the cell size in the foam and reduce the surface tension during foaming via reaction of the aromatic polyester polyol and, optionally, other components, with an organic polyisocyanate as described herein. Successful results have been obtained with silicone-polyoxyalkylene block copolymers, nonionic polyoxyalkylene glycols and their derivatives, and ionic organic salts as surfactants. Silicone based surfactants, particularly silicone-based polyoxyalkylene surfactants, are preferred surfactants for making the foams. Examples of surfactants useful in making the foams include, among others, polydimethylsiloxane-polyoxyalkylene block copolymers under the trade names Dabco® DC-193 and Dabco® DC-5315 (Air Products and Chemicals, Allentown, Pa.). Other suitable surfactants are organic surfactants, which are described in U.S. Pat. No. 4,751,251 to Thornsberry, including ether sulfates, fatty alcohol sulfates, sarcosinates, amine oxides, sulfonates, amides, sulfo-succinates, sulfonic acids, alkanol amides, ethoxylated fatty alcohol, and nonionics such as polyalkoxylated sorbitan. The amount of surfactant in the composition is preferably from about 0.02 wt % to about 2 wt %, based on the total weight of the mixture, more preferably about 0.05 wt % to about 1.0 wt %.

Other additives can also be included. Examples of such additives include processing aids, viscosity reducers, such as 1-methyl-2-pyrolidinone, propylene carbonate, nonreactive and reactive flame retardants, dispersing agents, plasticizers, mold release agents, antioxidants, compatibility agents, and fillers and pigments (e.g., carbon black and silica). The use of such additives is well known to those skilled in the art.

Particulate nucleating agents are not required for making the foams according to the processes disclosed herein, although foams and processes made using particulate or other nucleating agents are within the scope of the present invention.

Flame retardancy is a highly desirable feature in foams for many applications. An advantageous feature of the foams made according to the processes disclosed herein is that, when burned in a calorimeter, they exhibit monolithic char. This is believed to be due, in part, to the presence of the polyols in the foams. In addition, the foams can contain flame retardants.

Flame retardants for use in the foams (also referred to as flameproofing agents), can be reactive or nonreactive. Examples of suitable flame retardants are tricresyl phosphate, tris(2-chloroethyl) phosphate, tris(2-chloropropyl) phosphate, and tris(2,3-dibromopropyl) phosphate. An exemplary flame retardant is Antiblaze® 80, which is a tris(chloro propyl)phosphate and is commercially available from Rhodia, Inc. (Cranbury, N.J.). Examples of reactive flame retardants include halogen-substituted phosphates, such as chlorendic acid derivatives, tetrabromophthalic anhydride and derivatives, and various phosphorous-containing polyols. Inorganic or organic flameproofing agents can also be used, such as red phosphorus, aluminum oxide hydrate, antimony trioxide, arsenic oxide, ammonium polyphosphate and calcium sulfate, expandable graphite or cyanuric acid derivatives, e.g., melamine, or mixtures of two or more flameproofing agents, e.g., ammonium polyphosphates and melamine, and, if desired, polysaccharides such as cornstarch and flour, or ammonium polyphosphate, melamine, and expandable graphite and/or, if desired, aromatic polyesters, in order enhance the flameproofing characteristics of the resulting foam product. In general, from 2 to 50 parts by weight, preferably from 5 to 25 total parts by weight of one or more flameproofing agents may be used per 100 parts by weight of the aromatic polyester polyol. In one preferred embodiment of the invention, Antiblaze® 80 flame retardant is used in combination with a polysaccharide. For example, equal weights of Antiblaze® 80 flame retardant and a polysaccharide may be used.

The foam may also include a filler, including organic and inorganic fillers and reinforcing agents. Suitable fillers include inorganic fillers, including silicate minerals, such as for example, phyllosilicates such as antigorite, serpentine, hornblends, amphiboles, chrysotile, and talc; metal oxides, such as kaolin, aluminum oxides, titanium oxides and iron oxides; metal salts, such as chalk, barite and inorganic pigments, such as cadmium sulfide, zinc sulfide and glass; kaolin (china clay), aluminum silicate and co-precipitates of barium sulfate and aluminum silicate, and natural and synthetic fibrous minerals, such as wollastonite, metal, and glass fibers of various lengths. Suitable organic fillers include carbon black, melamine, colophony, cyclopentadienyl resins, cellulose fibers, polyamide fibers, polyacrylonitrile fibers, polyurethane fibers, and polyester fibers based on aromatic and/or aliphatic dicarboxylic acid esters, and carbon fibers.

The inorganic and organic fillers can be used individually or as mixtures and can be introduced into the aromatic polyester polyol foam forming composition or isocyanate side in amounts of 0.1 wt % to 40 wt % based on the weight of the aromatic polyester polyol foam forming composition or isocyanate side. For example, the filler and isocyanate can be fed together to the “A” side (isocyanate side), forming a prepolymer that is then mixed with the material from the “B” side.

Further details on other conventional additives that may be used are described by J. H. Saunders and K. C. Frisch, High Polymers, Volume XVI, Polyurethanes, Parts 1 and 2, Interscience Publishers 1962 and 1964, respectively, or Kunststoff-Handbuch, Polyurethane, Volume VII, Carl-Hanser-Verlag, Munich, Vienna, 1st and 2nd Editions, 1966 and 1983.

The rigid foams can be prepared by mixing together the organic polyisocyanate with the polyol and other ingredients at temperatures ranging from about 0° C. to about 150° C. Any order of mixing is acceptable provided the reaction of the polyisocyanate and aromatic polyester polyol does not begin until substantially all of the polyisocyanate and substantially all of the polyester polyol are mixed. Preferably, the polyisocyanate and the aromatic polyester polyol do not react until all ingredients have been combined. In a preferred embodiment, the B-side and A-side components are mixed for a short time together in an extruder with the blowing or foaming agent prior to the addition of D-side component at the point of the mixing equipment where all components come together, known as the “mixing head”. Alternatively, all components can be fed directly to the mixing head.

The foams may be produced by discontinuous or continuous processes, with the foaming reaction and subsequent curing being carried out, for example, in molds or on conveyors. The foam product may be suitably produced as a foam laminate by (a) contacting at least one facing sheet with the foam-forming mixture, and (b) foaming the mixture. The process is advantageously conducted in a continuous manner by depositing the foam-forming mixture onto a facing sheet(s) being conveyed along a production line, and preferably placing another facing sheet(s) on the deposited mixture. The deposited foam-forming mixture is conveniently thermally cured at a temperature from about 20° C. to 150° C. in a suitable apparatus, such as an oven or heated mold. Both free rise and restrained rise processes may be employed in the foam production.

One preferred process for forming a foam is described with reference to the apparatus shown in FIG. 1. The apparatus includes tanks A, B, C, and D for containing the foamable ingredients and additives such as surfactant, dye, blowing agent, etc. The tanks are charged with the foam-forming mixture in whatever manner is convenient and preferred for the given mixture. For instance, in the production of an isocyanurate foam, the foam-forming mixture can be divided into three liquid components, with polyisocyanate mixture in tank A; the polyol, surfactant, and blowing agent (water) in tank B; in tank C an optional second blowing agent, typically known as an “augmenting” or “trimming” blowing agent; and the catalytic agent in tank D. The tanks are individually connected to outlet lines 1, 2, 3, and 4, respectively. The temperatures of the ingredients in each tank are controlled to ensure satisfactory processing. The lines 1, 2, 3, and 4 form the inlet to metering pumps E, F, G, and H. The apparatus is also provided with a storage tank (not shown) for an optional frothing agent. The storage tank discharges frothing agent into conduit 5 which opens at “T”-intersection line 5 into line 1. A check valve 6 and ball valve 7 in conduit 5 ensure no backup of material toward the frothing agent storage tank. The frothing agent instead can be introduced in the same way into line 2 or both lines 3 and 4. The pumps E, F and G discharge respectively through lines 8, 9, and 10. Blowing agent from tank C is statically mixed in static mixer I with the B-side composition from tank B. Lines 8 and 11 are connected to the extruder J. Optionally, extruder J can be fed metered solids through a metered weigh feeder K. Line 12 and line 13, the D-side pump discharge, are respectively connected to the mixing head L by flexible lines. The apparatus is also provided with a roll M of lower facing material, and a roll M′ of upper facing material. Where only a lower facing material is used, the upper facing material can be replaced with a web coated with a release agent. The apparatus is also provided with metering rolls N and N′, and an oven O provided with vents 15 and 16 for introducing and circulating hot air. The apparatus also includes pull rolls P and P′, each of which preferably has a flexible outer sheath, and cutting means Q for cutting off side excess material and R for severing the faced foam plastic produced into finite lengths, thereby producing discrete panels.

As an example of the operation, tank A is charged with the organic polyisocyanate, tank B is charged with the polyol, blowing agent (water), and surfactant, tank C is charged with alternative or trimming blowing agent, and tank D is charged with the catalyst composition. The speeds of the pumps E, F, G, and H are adjusted to give the desired ratios of the ingredients contained in the tanks A, B, C and D whereupon these ingredients pass respectively into lines 1, 2, 3, and 4. When a froth-foaming process is conducted, the frothing agent is injected into line 1 upstream of metering pump E. The tank B and tank C ingredients pass through lines 9 and 10 and are mixed. Line 8 and line 9 are fed to the extruder exiting via line 12, whereupon line 12 is mixed with the catalyst from line 13 in the mixing head L and deposited therefrom. By virtue of rotation of the pull rolls N and N′, the lower facing material is pulled from the roll M, whereas the upper facing material is pulled from the roll M′. The facing material passes over idler rollers and is directed to the nip between the rotating metering rolls N and N′. The mixing head L sprays the foam in a circular pattern on the lower facing. In this manner, an even amount of material can be maintained upstream of the nip between the metering rolls N & N′. The composite structure at this point comprising lower and upper facing material M and M′ having there between a foamable mixture 14 now passes into the oven O and on along the generally horizontally extending conveyor. While in the oven O, the core expands under the influence of heat added by the hot air from vents 15 and 16 and due to the heat generated in the exothermic reaction between the polyol and isocyanate in the presence of the catalyst. The temperature within the oven is controlled by varying the temperature of the hot air from vents 15 and 16 in order to ensure that the temperature within the oven O is maintained within the desired limits of 100° F. to 300° F. (38° C. to 149° C.), preferably 175° F. to 250° F. (79° C. to 121° C.). The foam, under the influence of the heat added to the oven, cures to form faced foam plastic 17. The product 17 then leaves the oven O, passes between the pull rolls P and P′, and is cut by side edge and length cutting means Q and R into finite lengths, thereby forming discrete panels 18 of the product.

Numerous modifications to the above-described apparatus will be apparent to those skilled in the art. For example, the tanks A, B and C can be provided with refrigeration means in order to maintain the reactants at subambient temperatures. In one modification, the frothing agent is not delivered into lines 1 or 2, but is admixed with the foam-forming ingredient(s) in tanks A and/or B. Such an approach is especially advantageous for handling large amounts of highly volatile frothing agents, which can, for example, be apportioned in tanks A and B which are specially adapted (e.g., pressurized) to hold the frothing agent-containing formulations.

Another variation, not shown, is the addition of a reinforcing web that can be fed into the apparatus. Fiberglass fibers constitute a preferred web material characterized as a thin mat of long, generally straight glass fibers. By generally following the method of foam reinforcement described in Example 1 of U.S. Pat. No. 4,028,158 and utilizing a foam-forming mixture having the consistency of the liquid foamable mixture of this example, the glass mat becomes distributed within the foam core. By virtue of rotation of the pull rolls, reinforcing mat is pulled from its roll, through the nip of the metering rolls and downstream to form an expanded reinforcement material in the resulting structural laminate.

In a simplified variation, the metering of the foamable mixture can be accomplished without the need for metering rolls N and N′ by evenly applying the foamable mixture to the lower facer M and slightly restraining the rising foam so that so that a foam product of consistent density is achieved.

Any facing sheet that can be employed to produce building panels can be employed in the present invention. Examples of suitable facing sheets include, among others, those of kraft paper, aluminum, asphalt impregnated felts, and glass fiber mats, as well as combinations of two or more of the above. The foams can also be used, with or without one or more facers, in, for example, pipe insulation, pour-in-place applications, bunstock, and spray foam.

The foams can be used in a variety of applications. In the building and construction industry, it can be used as a component of laminated insulation panels for commercial built-up roofing applications; laminated insulation panels for siding applications; fabricated (cut from bunstock) insulation panels and configurations for roofing, piping, and various other insulation applications; in spray foam applications for roofs, tanks, pipes, refrigerators and walls; and as a component of simulated wood products for interior decor and furniture. In the refrigeration industry, the foam can be used in pour-in-place commercial refrigerator insulation. It can also be used in discontinuous panel lamination for freezer and warehouse insulation. For use in providing insulation, a rigid polyurethane foam prepared according to the methods disclosed herein can be applied, for example, onto a supporting substrate. Suitable substrates include structural elements such as, for example, ducts for heat and/or ventilation, walls, modular walls. In some embodiments, a sandwich structure can be formed, including two or more supporting substrates between which a rigid foam is interposed. Supporting substrates can be made, for example, of metal, concrete, brick, wood, plasterboard and the like. In other embodiments, a single supporting substrate can be used, upon which the foam elements are applied by spray application prior to completion of reaction between the elements to form the foam. For example, a delivery device containing the reaction mixture can be used to apply the foam ingredients at a desired location. Such application is suitable for, for example, pour-in-place formation of insulation during assembly of goods such as refrigerators. Further examples of uses and methods of application of foams prepared according to the processes disclosed herein can be found in U.S. patent application US2001/0014387 A1, the disclosures of which are hereby incorporated herein by reference in their entirety.

In some embodiments, a protective film can be applied to the foam on the side of the foam opposite to the supporting substrate. Optionally, a tackifying layer comprising, for example, a suitable adhesive, can be applied to the supporting substrate before application of the foam.

In the aircraft, aerospace, and marine industries, the foams can be used to form molded articles, and provide insulation and buoyancy.

A feature of foams prepared according to the processes described herein is a relatively small cell size, as compared to conventional closed-cell foams made from isocyanurates. The small cell size is believed to contribute to certain advantages of the foams, including 180-day aged thermal resistance as determined according to ASTM C518, and long term thermal resistance as measured according to CAN/ULC-S770. The foams have R values of at least about 4.5 R/in., preferably at least about 5.0 R/in., more preferably at least about 5.5 R/in., and even more preferably at least about 6 R/in.

The foams also exhibit enhanced burn performance characterized by the formation of a solid monolithic sheet of char, a pass rate of at least about 66% under calorimeter testing using test method FM 4450, and low flame spread and smoke values when tested under ASTM E84. The term “monolithic char” is used herein to indicate that upon burning in a calorimeter test, a foam forms a substantially continuous sheet. In contrast, conventional foams, when tested under the same calorimetry conditions, break into pieces or separate, e.g., by cracking, after charring. Monolithic charring is advantageous because it indicates that sheets, for example, for insulation, made from the foams are likely to maintain their structural integrity upon burning in a fire, longer than would be expected for conventional foams. In particular, when a foam remains in a substantial uniform sheet, tar and debris are less likely to flow past the foam during burning than for conventional foams that break up and/or separate upon burning.

The relatively low average BTU/min. values for Examples 1, 4, 5, 6b, 8a and 8b illustrate the burn characteristics of the foams. Examples 4 and 6a did not exhibit failure in the calorimeter test until the last 3 to 5 minutes of the test. The water/pentane blown systems had low Class I or Class II E84 flame spread values of 28, 28 and 25 in Examples 2,11 and 6b respectively. Foams prepared in Examples 12 and 13, which are predominately (example 12) or entirely (example 13) water-blown foams, had Class I E84 flame spread values of 20. All foams described in the present examples exhibited low smoke values.

A commonly used method for measuring cell size in foams is an optical method, ASTM D3576. However, cell size measurements obtained by the ASTM D3576 optical method may be reliable only for rigid foams having equivalent diameter cell size of at least 200 microns. For cells of smaller diameter, a more precise method utilizing Scanning Electron Microscopy (SEM) and Image Analysis is preferred, and was used in measuring cell size in the foams disclosed herein. SEM analysis gives the average long axis of the cells and the mean equivalent diameter. Mean equivalent diameter is the diameter of a sphere whose surface area would be equal to the surface area of the cell. Values reported elsewhere herein are mean equivalent diameters obtained by SEM unless expressly otherwise indicated.

If the images are obtained by ordinary light optical microscopy, such as, for example, the confocal analysis technique designated ASTM D3576, the two-dimensional image can show several layers of cells projected together; thus, what appear to be several small cells may actually be a projected image of a few larger cells that exist at different depths in the sample section being examined. Thus, an average cell size measurement obtained from such overlapping images can be smaller than the true average cell size. Also, for confocal imaging analysis, similar to light microscopy, a sample must be cut to about 1½ times as thick as the cell. Cutting materials such as foam into slices less than about 150 microns thick can be difficult. Moreover, determination of cell size by confocal microscopy requires an assumption of spherical cells. SEM images better show the three-dimensional features of the cells than do confocal microscopy images. Image analysis of those images that contain three-dimensional information are thus believed to provide more accurate cell size measurements.

Thus, for example, the mean cell diameter of a foam prepared according to the methods described herein can have cells having a mean diameter of about 151 microns or less, and the same cells when measured by confocal imaging may have mean diameters of about 50 microns or less.

The invention is further illustrated by the following examples, in which all parts and percentages are by weight unless otherwise indicated.

### EXAMPLES 1-13

### Laminate Preparation

Structural laminates were prepared from the ingredients and quantities thereof shown in the Table 1. A free rise process was employed. For each structural laminate, the B-side (polyol) component was charged to tank B, the D-side (catalyst) component was charged to tank D, the C-side (blowing agent) component was charged to tank A, and the A-side (polymeric MDI) component was charged to tank A. Laminate examples 1 through 9 utilized fibrous glass mat facings.

In each case, the C-side component was statically mixed with the B-side component prior to mixing with the A-side component. The A-side component was fed to an extruder (J) turning at approximately 650 RPM at one end and mixed for approximately 5 to 10 seconds with the B-side component in the extruder. In Examples 3 and 5, a solid saccharide was also fed into the extruder and mixed with the A-side component prior to mixing with the B-side & D-side components. In the mixing head, the D-side component was mixed with the other foam components exiting the extruder. The mix head was a spiral grooved mix head assembly spinning between approximately 5000 to 6000 RPM. Top and bottom fibrous glass mat facings were fed together toward the nip of metering rolls M and M′. The foam forming mixture was metered and deposited onto the lower facing. The laminates proceeded through the laminator oven (O) where the oven's conveyor slats rose and fell to establish the final product thickness. The laminate boards were cut to yield the foam board Examples 1 through 13.

Properties of the foam boards of examples 1-10 are given in Table 1. Additional properties of examples 11-13 are given in Table 2. Standard test methods therein identified were used except in the case of cell size determination. Long term thermal resistance (LTTR), closed cell content, compressive strength, and dimensional stability were conducted by R&D Services, Inc., Cookeville, Tenn.

TABLE 1
Production of Structural Laminates

| INGREDIENTS | | | | | | | | | | | | |
|---|---|---|---|---|---|---|---|---|---|---|---|---|
| (wt % total polymer) | EX1 | EX2 | EX3 | EX4 | EX5 | EX6a | EX6b | EX7 | EX8a | EX8b | EX9 | EX10 |
| “A” Component | | | | | | | | | | | | |
| Polymeric | 50.04 | 50.04 | 48.50 | 57.67 | 58.34 | 50.48 | 50.48 | 60.26 | 68.79 | 68.79 | 57.39 | 62.64 |
| Isocyanate⁽¹⁾ | | | | | | | | | | | | |
| “B” Component | | | | | | | | | | | | |
| Polyol A⁽²⁾ | 39.74 | 39.74 | 38.42 | | | | | | | | 31.59 | |
| Polyol B⁽³⁾ | | | | 31.61 | 28.22 | 39.12 | 39.12 | 32.57 | 23.70 | 23.70 | | 27.90 |
| Water | 0.60 | 0.60 | 1.03 | 1.07 | 1.45 | 1.02 | 1.02 | 2.02 | 1.99 | 1.99 | 0.35 | 0.95 |
| TCPP⁽⁴⁾ | 3.78 | 3.78 | 3.65 | 3.95 | 3.53 | 3.72 | 3.72 | 3.75 | 3.44 | 3.44 | 3.24 | 3.49 |
| DC-193⁽⁵⁾ | 0.87 | 0.87 | 0.85 | 0.95 | 0.85 | 0.86 | 0.86 | 0.81 | 0.83 | 0.83 | 0.26 | 0.84 |
| Rhodia ESC-70A/B⁽⁶⁾ | | | | | | | | | | | 0.53 | |
| Organic Filler^{(7) dry wt.} | | | 3.21 | | 3.53 | | | | | | | |
| “C” Component | | | | | | | | | | | | |
| iso/cyclo pentane⁽⁸⁾ | 4.57 | 4.57 | 4.42 | 3.95 | 2.82 | 4.11 | 4.11 | 0 | 0 | 0 | 4.74 | 3.49 |
| “D” Component | | | | | | | | | | | | |
| Dabco 33LV⁽⁹⁾ | 0.41 | 0.41 | 0.39 | | | 0.39 | 0.39 | 0.33 | | | | |
| Polycat P-18⁽¹⁰⁾ | | | | 0.32 | 0.62 | 0.31 | 0.31 | 0.26 | 0.51 | 0.51 | 0.46 | 0.28 |
| Potassium octoate⁽¹¹⁾ | | | | 0.47 | 0.93 | | | | 0.75 | 0.75 | 1.45 | 0.42 |
| Potasium acetate⁽¹²⁾ | | | | | 0.21 | | | | | | 0.14 | |
| Total | 100 | 100 | 100 | 100 | 100 | 100 | 100 | 100 | 100 | 100 | 100 | 100 |
| Index | 1.18 | 1.18 | 1.05 | 1.37 | 1.36 | 1.05 | 1.05 | 1.05 | 1.36 | 1.36 | 1.65 | 1.69 |
| FOAM PROPERTIES | | | | | | | | | | | | |
| Board Thickness (in.) | 1.5 | 2.5 | 1.5 | 1.5 | 1.5 | 1.5 | 2.5 | 1.5 | 1.5 | 2.5 | 2.5 | 1.5 |
| Core Density⁽¹³⁾ | 1.99 | 1.93 | 2.09 | 1.78 | 1.71 | 1.97 | 1.93 | 2.11 | 2.29 | 1.96 | 1.71 | 1.94 |
| Closed cell % (ASTM | 91.9 | 86.3 | 89.2 | 45.9 | 49.2 | 40.0 | 85.8 | 93.1 | 77.6 | 79.3 | 37.0 | 71.3 |
| D2856) | | | | | | | | | | | | |
| Compressive Strength | 30.6 | 20.7 | 17.1 | 15.4 | 14.2 | 21.4 | 13 | 23.9 | 36.2 | 16.3 | 16.5 | 23.3 |
| (psi) (ASTM D1621) | | | | | | | | | | | | |
| Cell Size (microns) by | 110 | NT | 122 | 137 | 133 | 146 | 107 | 124 | 140 | 160 | NT | 151 |
| SEM | | | | | | | | | | | | |
| Cell Size (microns) by | | | 45 | | | | 43 | | | | | 49 |
| Optical (confocal) | | | | | | | | | | | | |
| analysis | | | | | | | | | | | | |
| k-factors | | | | | | | | | | | | |
| (ASTM C518) | | | | | | | | | | | | |
| (Btu.in/ft²-hr-° F.) | | | | | | | | | | | | |
| 1 week | 0.140 | 0.138 | 0.146 | 0.156 | 0.169 | 0.171 | 0.140 | 0.160 | 0.161 | 0.168 | 0.156 | 0.158 |
| 90/180 days⁽¹⁴⁾ | 0.164 | NT | 0.159 | 0.181 | 0.190 | 0.221 | 0.207 | 0.227 | 0.228 | 0.223 | NT | 0.184 |
| ASTM E84 | | | | | | | | | | | | |
| Flame spread | NT | 28 | NT | NT | NT | NT | 25 | NT | NT | NT⁽¹⁵⁾ | 25 | NT |
| Smoke | NT | 119 | NT | NT | NT | NT | 126 | NT | NT | NT | 328 | NT |
| Calorimeter (FM4450) | | | | | | | | | | | | |
| Average Btu/ft2/min | 206 | | | 228 | 194 | 228 | | 154 | 208 | | | |
| 3 Min Btu/ft2/min | 287 | | | 498 | 295 | 474 | | 288 | 265 | | | |
| (max is 410) | | | | | | | | | | | | |
| | Pass | NT | NT | Fail | Pass | FailNT | | Pass | Pass | NT | NT | NT |

⁽¹⁾Bayer Mondur 489 (Bayer Corporation, Pittsburg, Pennsylvania)
⁽²⁾Aromatic Polyester Polyol characterized by functionality of 2.7-3.0, OHN 347, AN 2.06, visc ˜8 M cPs @25 C
⁽³⁾Aromatic Polyester Polyol characterized by functionality 2.7-3.0, OHN 343, AN 2.3, visc. ˜16 M cPs @ 25 C
⁽⁴⁾Tris (2-chloropropyl) phosphate; Rhodia Antiblaze 80 (Rhodia, Inc., Cranbury, New Jersey)
⁽⁵⁾Silicone surfactant by Air Products (Air Products and Chemicals, Inc., Allentown, Pennsylvania)
⁽⁶⁾Non silicone surfactant by Rhodia (Rhodia, Inc., Cranbury, New Jersey)
⁽⁷⁾Bay State Milling Flour (14% wet) (Bay State Milling Company, Quincy, Massachusetts)
⁽⁸⁾50/50 wt % isopentane/cyclopentane blend
⁽⁹⁾Urethane catalysis by Air Products (Air Products and Chemicals, Inc., Allentown, Pennsylvania)
⁽¹⁰⁾Urethane catalysis by Air Products (Air Products and Chemicals, Inc., Allentown, Pennsylvania)
⁽¹¹⁾15% Potassium Octoate (K-15) (The Shepperds Chemical Company, Norwood, Ohio)
⁽¹²⁾48% Potassium Acetate (Pelron 9648) (The Ele' Corporation, Lyons, Illinois)
⁽¹³⁾Core density is defined as 60% of the center mass of foam with the facing cut off.
⁽¹⁴⁾90 day data aged at 160° F.
⁽¹⁵⁾Mechanically stressed foam; distorted on cutting from facing

TABLE 2
Production of Structural Laminates

| INGREDIENTS (wt % total polymer) | EX11 | EX12 | EX13 |
|---|---|---|---|
| “A” Component | | | |
| Polymeric Isocyanate⁽¹⁾ | 46.80 | 54.70 | 59.81 |
| “B” Component | | | |
| Polyol A⁽²⁾ | 41.71 | 36.10 | |
| Polyol B⁽³⁾ | | | 27.68 |
| Water | 0.42 | 1.50 | 1.55 |
| TCPP⁽⁴⁾ | 4.63 | 4.01 | 2.77 |
| DC-193⁽⁵⁾ | 0.88 | 0.88 | 1.00 |
| EO-sorbitol⁽⁶⁾ | | | 1.38 |
| “C” Component | | | |
| iso/cyclo pentane⁽⁸⁾ | 5.33 | | |
| HFC-134a | | 2.81 | |
| “D” Component | | | |
| Dabco 33LV⁽⁹⁾ | 0.0 | 0.0 | 0.0 |
| Total | 100 | 100 | 100 |
| Index | 1.15 | 1.05 | 1.05 |
| FOAM PROPERTIES | | | |
| Board Thickness (in.) | 2.5 | 2.5 | 4.0 |
| Lay Down Density (pcf)⁽¹⁰⁾ | 2.00 | 2.10 | 2.80 |
| Core Density (pcf)⁽¹¹⁾ | 1.90 | 2.00 | 2.70 |
| Closed cell % (ASTM 2856) | 95.3 | 91.7 | 84.6 |
| Compressive Strength (psi) | 20.3 | 25.0 | 24.8 |
| (ASTM D1621) | | | |
| Cell Size (microns) by SEM | 163 | 156 | 179 |
| k-factors (ASTM C518) | | | |
| (Btu-in./ft²-hr-° F.) | | | |
| 1 week | 0.140 | 0.138 | 0.146 |
| 180 day | 0.155 | 0.170 | 0.165 |
| ASTM E84 | | | |
| Flame spread | 28 | 20 | 20 |
| Smoke | 191 | 173 | 184 |

| LTTR (R/in.) | | | | | | |
|---|---|---|---|---|---|---|
| CAN/ULC-S770 | | | | | | |
| (ft²-hr-° F./Btu-in.) | | | | | | |
| EX11 | 6.07 | 6.32 | NT | 6.49 | NT | NT |
| EX12 | 5.28 | 5.43 | NT | 5.56 | NT | NT |
| EX13 Unfaced⁽¹²⁾ | NT | NT | 4.65 | NT | 4.83 | 4.96 |
| Board thickness (in.) | 1.5″ | 2.5″ | 3.0″ | 3.5″ | 4.0″ | 5.0″ |

⁽¹⁾Bayer Mondur 489 (Bayer Corporation, Pittsburg, Pennsylvania)
⁽²⁾Aromatic Polyester Polyol characterized by functionality of 2.7-3.0, OHN 340, AN 2.9, visc ˜13 M cPs @25 C
⁽³⁾Aromatic Polyester Polyol characterized by functionality 2.7-3.0, OHN 383, AN 2.6, visc. ˜10 M cPs @ 25 C
⁽⁴⁾Tris (2-chloropropyl) phosphate; Rhodia Antiblaze 80 (Rhodia, Inc., Cranbury, New Jersey)
⁽⁵⁾Silicone surfactant by Air Products (Air Products and Chemicals, Inc., Allentown, Pennsylvania)
⁽⁶⁾EO-sorbitol polyether polyol characterized by functionality 6, OHN 734 (The Ele' Corporation, Lyons, Illinois)
⁽⁷⁾50/50 wt % isopentane/cyclopentane blend
⁽⁸⁾HFC-134a (EI DuPont Co., Wilmington, Delaware)
⁽⁹⁾Urethane catalysis by Air Products (Air Products and Chemicals, Inc., Allentown, Pennsylvania)
⁽¹⁰⁾Lay Down density is defined as 100% of the mass of foam with the facing cut off.
⁽¹¹⁾Core density is defined as 60% of the center mass of foam with the facing cut off.
⁽¹²⁾facer severely distorted on cutting and was not used in LTTR measurements

Foams prepared according to the present invention using in the reaction mixture more than 2.5 times the typical water content in commercial foams compare favorably with regard to thermal resistance to such commercial foams. The commercial formulation used for reference with regard to water content was the laminate formulation recommended by Kosa in its technical bulletin for Kosa Terate® 3522 aromatic polyester polyol (technical bulletin, page 3).

Examples 1 and 3 illustrate 1.5 inch laminate polyurethane indexed foam utilizing a water/pentane blowing system containing about 4 times and 7 times respectively the typical water content of a foaming mix. The laminates made in Examples 1 and 3 have 180-day-aged k-factors of 0.164 and 0.159 respectively, and R/in. values of 6.09 and 6.29, respectively. Thus, foams produced according to the processes disclosed herein have thermal properties comparable to those of commercial foams, even though a much higher water content is used in making the present foams, in contrast to the likely expectation that higher k-factors and lower R values would be obtained with the higher water content

Example 11 further illustrates the properties of high water-content, pentane co-blown polyurethane indexed foams with high thermal resistance, having long term thermal resistance values (LTTR) exceeding those of a foam produced commercially by Atlas Roofing Corporation. The data from Example 11 are repeated below, in comparison with data from Atlas Roofing Technical Bulletin Number 93-1007 C:

| | R/in. | | |
|---|---|---|---|
| LTTR Board Thickness | 1.5″ | 2.5″ | 3.5″ |
| Atlas Roofing Technical Bulletin | 6.00 | 6.12 | 6.20 |
| Number: 93-1007 C | | | |
| EX11 | 6.07 | 6.32 | 6.49 |

The LTTR data for the foams made according to the present invention are surprising because the thermal conductivity of carbon dioxide is approximately 30% higher than pentane. In view of this difference in conductivity, the results obtained for Example 12 and Example 13 are surprising and unexpected. Example 12, in which HFC-134a was used as a frothing agent, has significantly improved thermal resistance. Both the 180-day-aged thermal resistance and long term thermal resistance are unexpectedly good for a predominantly water blown foam (estimated CO₂ contribution to foam volume is 80% of the gaseous volume). Example 13 additionally has unexpectedly high thermal resistance for an entirely water blown foam.

### Cell Size Measurement

Cell sizes shown in Tables 1 and 2 were determined using Image Analysis of scanning electron microscope (SEM) images, as described hereinabove. As an illustration of the variability of cell size measurements with measurement technique, optical measurement by confocal analysis was used to measure cell sizes in the foams prepared in examples 3, 6a, and 10. The measurements obtained were: 122 microns by SEM and 45 microns by confocal analysis; 107 microns by SEM and 43 microns by confocal analysis; and 151 microns by SEM and 49 microns by confocal analysis, respectively.

Samples were sliced to prepare a surface for SEM imaging. Images are collected using a JEOL840 SEM. The images are of only the top surface of the cut slice, and provide an indication of where each cell's boundary starts. The long axes of the cells are measured using the SEM images collected. Average cell size can then be calculated. Average “equivalent diameter” can also be used to describe the cell size. Ten cells of each sample are randomly taken to estimate the aspect ratio value for the sample.

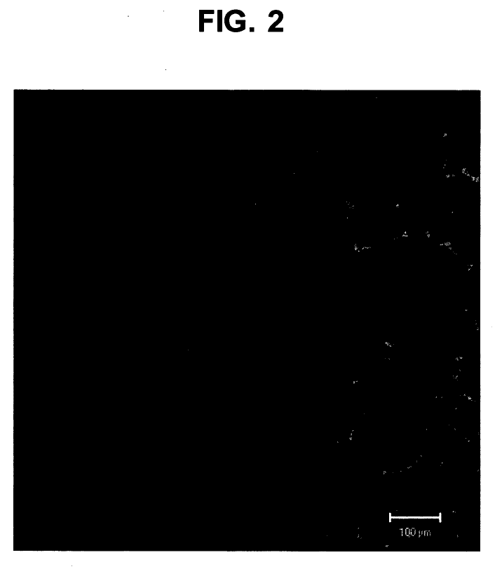

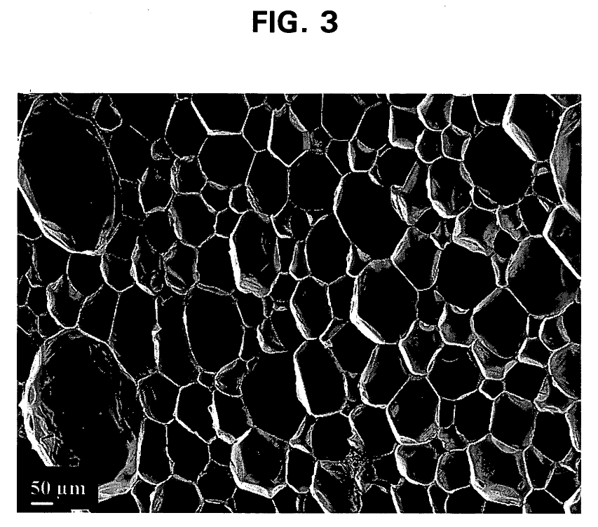

FIG. 2 is an optical confocal micrograph image the foam produced according to Example 3. FIG. 3 is a scanning electron micrograph of the foam produced according to Example 3.

Table 3 compares the cell sizes of representative samples of currently available commercial products to a foam prepared according to Example 1.

TABLE 3
Equivalent Diameter Cell Size Comparisons

| | EX1 | CE1 | CE2 | CE3 |
|---|---|---|---|---|
| Cell Size | 110 | 158 | 162 | 255 |
| (microns) | | | | |

CE1 is Atlas AC^{(R)} FoamII (Atlas Roofing Corporation, Meridian, Mississippi) blown with n-pentane
CE2 is Atlas AC^{(R)} FoamIII (Atlas Roofing Corporation, Meridian, Mississippi) blown with n-pentane
CE3 is Firestone Laminate Board (Firestone Building Products, Carmel, Indiana) blown with HCFC-141b

What is claimed is:

1. A closed-cell foam prepared from a mixture comprising a polyol component comprising an aromatic polyester polyol having a hydroxyl functionality of at least 2, a polyisocyanate, in such quantity that the isocyanate index in the mixture is less than 3.5; and a blowing agent comprising water, said foam comprising cells having mean diameters of about 160 microns or less as measured by SEM, wherein said foam has an aged insulation R value of at least 4.5 R/in.

2. The foam of claim 1, wherein said mixture further comprises at least one co-blowing agent having a boiling point less than about 60° C.

3. The foam of claim 2, wherein the co-blowing agent comprises at least one compound selected from C₂-C₆ hydrocarbons and hydrofluorocarbons.

4. The foam of claim 3, wherein the co-blowing agent comprises at least one compound selected from isopentane, n-pentane, cyclopentane and 1,1,1,2-tetrafluoroethane.

5. The foam of claim 1 wherein said foam has an aged insulation value of at least about 5.0 R/In.

6. The foam of claim 1 wherein said foam has an aged insulation value of at least about 5.5 R/In.

7. The foam of claim 1 wherein said foam has an aged insulation value of at least about 6 R/in.

8. The foam of claim 4, wherein said co-blowing agent comprises one or more of isopentane, n-pentane, and cyclopentane.

9. The foam of claim 3 wherein said co-blowing agent is a hydrofluorocarbon.

10. The foam of claim 1, wherein the polyisocyanate is a prepolymer made by reaction of an isocyanate with a polyol to form a prepolymer isocyanate.

11. The foam of claim 1, wherein the polyisocyanate is a polymethylenepolyphenylene-polyisocyanate.

12. The foam of claim 1, wherein said polyol component comprises at least 50 weight percent of one or more aromatic polyester polyols and less than 50 weight percent of a polyether polyol, based on the total weight of the polyol component.

13. The foam of claim 1, wherein said polyol component comprises at least 75 weight percent of one or more aromatic polyester polyols, based on the total weight of the polyol component.

14. The foam of claim 1 wherein said polyol component consists essentially of one or more aromatic polyester polyols.

15. The foam of claim 1, wherein the aromatic polyester polyol is made from a reaction mixture of an aromatic acid component; a glycol component; and a polyhydroxyl polyol that is substantially free of alkoxylated or partially alkoxylated polyhydroxyl polyols.

16. The foam of claim 14 wherein the polyhydroxyl polyol is selected from alpha-methyl glucoside, glycerol, trimethylol propane, pentaerythritol, and sugar alcohols that contain no aldehyde functionality.

17. The foam of claim 16, wherein said sugar alcohol is selected from xylose, mannitol, and sorbitol.

18. The foam of claim 17, wherein said sugar alcohol is sorbitol.

19. The foam of claim 1, further comprising a surfactant.

20. The foam of claim 19 wherein the surfactant is a silicone-based surfactant.

21. The foam of claim 1, wherein the mean cell diameter is about 140 microns or less as measured by SEM.

22. The foam of claim 1, wherein the mean cell diameter is about 130 microns or less as measured by SEM.

23. The foam of claim 1, wherein the mean cell diameter is about 125 microns or less as measured by SEM.

24. The foam of claim 1, wherein the mean cell diameter is about 110 microns or less as measured by SEM.

25. The foam of claim 1, wherein the mean cell diameter is about 50 microns or less as measured by confocal imaging.

26. The foam of claim 14 wherein the polyol component comprises at least about 5 weight percent of an aromatic polyester polyol having an average functionality of about 2.5 or greater.

27. The foam of claim 14 wherein the polyol component comprises at least about 25 weight percent of an aromatic polyester polyol having an average functionality of about 2.5 or greater.

28. The foam of claim 27 wherein said aromatic polyester polyol has an average functionality from about 2.7 to about 3.0.

29. A closed-cell foam prepared from a mixture comprising a polyol component comprising an aromatic polyester polyol having a hydroxyl functionality of at least 2, a polyisocyanate, and a blowing agent comprising water, said foam having an insulation R value of at least 4.5 R/In and exhibiting monolithic charring when burned in a calorimeter, wherein said foam has an aged insulation R value of at least 4.5 R/in.

30. The foam of claim 29, wherein said mixture further comprises at least one co-blowing agent having a boiling point less than about 60° C.

31. The foam of claim 30, wherein the co-blowing agent comprises at least one compound selected from C₂-C₆ hydrocarbons and hydrofluorocarbons.

32. The foam of claim 31, wherein the co-blowing agent comprises at least one compound selected from isopentane, n-pentane, cyclopentane and 1,1,1,2-tetrafluoroethane.

33. The foam of claim 29 wherein said foam has an insulation value of at least about 5.0 R/In.

34. The foam of claim 29 wherein said foam has an insulation value of at least about 5.5 R/In.

35. The foam of claim 30, wherein said co-blowing agent comprises one or more of isopentane, n-pentane, and cyclopentane.

36. The foam of claim 31 wherein said co-blowing agent is a hydrofluorocarbon.

37. The foam of claim 29, wherein the polyisocyanate is a prepolymer made by reaction of an isocyanate with a polyol to form a prepolymer isocyanate.

38. The foam of claim 29, wherein the polyisocyanate is a polymethylenepolyphenylene-polyisocyanate.

39. The foam of claim 29, wherein the polyol component comprises at least 50 weight percent of one or more aromatic polyester polyols and less than 50 weight percent of a polyether polyol, based on the total weight of the polyol component.

40. The foam of claim 29, wherein the polyol component comprises at least 75 weight percent of one or more aromatic polyester polyols, based on the total weight of the polyol component.

41. The foam of claim 29 wherein said polyol component consists essentially of one or more aromatic polyester polyols.

42. The foam of claim 29, wherein the aromatic polyester polyol is made from a reaction mixture of an aromatic acid component; a glycol component; and a polyhydroxyl polyol that is substantially free of alkoxylated or partially alkoxylated polyhydroxyl polyols.

43. The foam of claim 42 wherein the polyhydroxyl polyol is selected from alpha-methyl glucoside, glycerol, trimethylol propane, pentaerythritol, and sugar alcohols that contain no aldehyde functionality.

44. The foam of claim 43, wherein said sugar alcohol is selected from xylose, mannitol, and sorbitol.

45. The foam of claim 43, wherein said sugar alcohol is sorbitol.

46. The foam of claim 29, further comprising a surfactant.

47. The foam of claim 46 wherein the surfactant is a silicone-based surfactant.

48. The foam of claim 29, wherein the mean cell diameter is about 140 microns or less as measured by SEM.

49. The foam of claim 29, wherein the mean cell diameter is about 130 microns or less as measured by SEM.

50. The foam of claim 29, wherein the mean cell diameter is about 125 microns or less as measured by SEM.

51. The foam of claim 29, wherein the mean cell diameter is about 110 microns or less as measured by SEM.

52. The foam of claim 29, wherein the mean cell diameter is about 50 microns or less as measured by confocal imaging.

53. The foam of claim 29 wherein the mixture comprises about 25 weight percent of an aromatic polyester polyol having an average functionality of about 2.5 or greater, based on the total weight of the mixture.

54. The foam of claim 53 wherein said aromatic polyester polyol has an average functionality from about 2.7 to about 3.0.

55. A process for making a foam, comprising providing a first polyol, said first polyol being an aromatic polyester polyol having a hydroxyl functionality equal to or greater than 2, and optionally one or more additional polyols; providing a polyisocyanate; providing a blowing agent comprising water; mixing said aromatic polyester polyol, said polyisocyanate and said blowing agent at a temperature from about 0° C. to about 150° C. in the presence of a catalyst to form a reaction mixture; and allowing said aromatic polyester and said polyisocyanate to react to form said foam, provided that said aromatic polyester polyol and said polyisocyanate do not react until substantially all of said aromatic polyester polyol, said polyisocyanate and said catalyst have been combined.

56. The process of claim 55, wherein said mixture further comprises at least one co-blowing agent having a boiling point less than about 60° C.

57. The process of claim 56, wherein the co-blowing agent comprises at least one compound selected from C₂-C₆ hydrocarbons and hydrofluorocarbons.

58. The process of claim 57, wherein the co-blowing agent is isopentane, n-pentane, cyclopentane or 1,1,1,2-tetrafluoroethane or a mixture thereof.

58. The process of claim 55, wherein the polyisocyanate is a prepolymer made by reaction of an isocyanate with a polyol to form a prepolymer isocyanate.

59. The process of claim 55, wherein the polyisocyanate is a polymethylenepolyphenylene-polyisocyanate.

60. The process of claim 55, wherein the total quantity of said first polyol and said additional polyols comprises at least 50 weight percent of one or more aromatic polyester polyols having a hydroxyl functionality of at least 2, and less than 50 weight percent of a polyether polyol.

61. The process of claim 55, wherein the total quantity of said first polyol and said additional polyols comprises at least 75 weight percent of one or more aromatic polyester polyols having a hydroxyl functionality of at least 2.

62. The process of claim 55, wherein the total quantity of said first polyol and said additional polyols consists essentially of one or more aromatic polyester polyols having a hydroxyl functionality of at least 2.

63. The process of claim 55, wherein the aromatic polyester polyol is made from a reaction mixture of an aromatic acid component; a glycol component; and a polyhydroxyl polyol that is substantially free of alkoxylated or partially alkoxylated polyhydroxyl polyols.

64. The process of claim 63 wherein the polyhydroxyl polyol is selected from alpha-methyl glucoside, glycerol, trimethylol propane, pentaerythritol, and sugar alcohols that contain no aldehyde functionality.

65. The process of claim 64, wherein said sugar alcohol is selected from the group of xylose, mannitol, and sorbitol.

66. The process of claim 64, wherein said sugar alcohol is sorbitol.

67. The process of claim 55, wherein said reaction mixture further comprises a surfactant.

68. The process of claim 67 wherein the surfactant is a silicone-based surfactant.

69. The process of claim 55, wherein the mean cell diameter is about 140 microns or less as measured by SEM.

70. The process of claim 55, wherein the mean cell diameter is about 130 microns or less as measured by SEM.

71. The process of claim 55, wherein the mean cell diameter is about 125 microns or less as measured by SEM.

72. The process of claim 55, wherein the mean cell diameter is about 110 microns or less as measured by SEM.

73. The process of claim 55, wherein the mean cell diameter is about 50 microns or less as measured by confocal imaging.

74. An insulation panel comprising the foam of claim 1.

75. The insulation panel of claim 74 wherein said panel is laminated.

76. A roof comprising the insulation panel of claim 74.

77. Building siding comprising the insulation panel of claim 74.

78. An insulation material comprising the foam of claim 1, wherein said foam is applied as spray foam.

79. A method for insulating a roof, tank, pipe, wall, or refrigerator comprising applying to said roof, tank, pipe, wall or refrigerator the foam of claim 1.

80. A method according to claim 79 wherein said foam is applied to a refrigerator by a pour-in-place application.

81. A molded article for aircraft or marine application comprising the foam of claim 1.

82. A molded simulated wood article comprising the foam of claim 1.
